(19) United States
(12) Patent Application Publication
(10) Pub. No.: US 2003/0072437 A1
(43) Pub. Date: Apr. 17, 2003

(54) T1E1.4 compliant filter circuit

(76) Inventors: Frederick J. Kiko, Carlsbad, CA (US); Lucian E. Scripca, Encinitas, CA (US)

Correspondence Address: DAVIS CHIN, 16061 S. 94TH AVENUE, ORLAND HILLS, IL, 60477-4623, US

(21) Appl. No.: 09/978,236

(22) Filed: Oct. 16, 2001

(51) Int. Cl. H04M 1/00; H04M 9/00

(52) U.S. Cl. 379/399.01

(57) ABSTRACT

A T1E1.4 compliant filter circuit used in telecommunication systems for interconnecting between incoming telephone lines and a subscriber's telephone termination equipment located at a subscriber's premises for blocking DSL signals so as to prevent interference problems between DSL devices and the subscriber's termination equipment. The compliant filter circuit includes first and second inductors connected in series at a first common point and extending between a first input terminal and a first output terminal. Third and fourth inductors are connected in series at a second common point and extending between a second input terminal and a second output terminal. A first capacitor has its ends connected across the first and second common points. Second and third capacitors are connected in parallel with the respective second and fourth inductors.

### BACKGROUND OF THE INVENTION

This invention relates generally to telecommunication systems and more particularly, it relates to a T1E1.4 compliant filter circuit used in telecommunication systems for interconnecting between incoming telephone lines and a subscriber's or customer's telephone termination equipment such as a telephone set located at a subscriber's premises for blocking DSL signals so as to prevent interference problems between DSL devices and the subscriber's termination equipment.

In view of telephone technology of today, there are many telephone subscribers or customers that have a personal computer with a modem located on their premises. Generally, the computer user desires to receive DSL (an acronym for Digital Subscriber Line) signals continuously from the Internet over the same telephone lines via an Internet Server Provider (ISP) In order to increase the speed of downloading of information from the Internet, a DSL network interface is typically purchased and installed between the incoming telephone lines and the user's computer. However, since one or more telephone subscriber's network termination equipment such as telephone sets (including cordless types), answering machines, facsimile (FAX) machines, 56 kb/s and lower rate modems, automatic dialers, and/or satellite receivers are also connected to the same incoming telephone lines via internal house wiring, DSL interference problems may be caused by the network termination equipment (e.g., intermodulation distortion) which can significantly reduce the data rate as well as create audible noise in the voice band and/or can cause data errors.

While there is known a simple low pass filter circuit consisting of two inductors and a capacitor connected across the two inductors which may be able to provide sufficient attenuation for blocking of the DSL signals, the values of the inductances and the capacitance are required to be quite large. However, these large values create too much attenuation distortion of the telephone signals in the voice band. Such a low pass filter is illustrated in FIG. 17 of co-pending application Ser. No. 09/929,775 and filed on Aug. 15, 2001 entitled “COMPACT WALL PHONE FILTER HOUSING UNIT”.

Accordingly, it would be desirable to provide a compliant filter circuit for connection to the telephone termination equipment for attenuating DSL signals in the DSL frequency band of 25 KHz to 1.1 MHZ without adversely affecting voice signals in the voice frequency band of 0 to 4 KHz. The T1E1.4 compliant filter circuit of the present invention is of a modular design so as to facilitate quick and easy connections between the incoming telephone lines and the telephone termination equipment. The T1E1.4 compliant filter circuit serves to form an elliptical zero at the beginning of the DSL frequency band of 25 KHz so as to provide sufficient attenuation in the frequency range of 25-35 KHz for meeting the specifications of the T1E1.4 voice band requirements.

### SUMMARY OF THE INVENTION

Accordingly, it is a general object of the present invention to provide a T1E1.4 compliant filter circuit which effectively and efficiently reduces interference problems between DSL devices and network termination equipment.

It is an object of the present invention to provide a T1E1.4 compliant filter circuit for connection to telephone termination equipment so as to prevent interference problems.

It is another object of the present invention to provide a T1E1.4 compliant filter circuit used in telecommunication systems for interconnecting between incoming telephone line and customer's termination equipment so as to attenuate sufficiently DSL signals in the frequency range of 25-35 KHz while affecting minimally the voice frequency band of 0-4 KHz.

It is still another object of the present invention to provide a T1E1.4 compliant filter circuit which is of a modular design so as to facilitate quick and easy connections between incoming telephone lines and customer's termination equipment.

It is still yet another object of the present invention to provide a T1E1.4 compliant filter circuit which is comprised of four low cost inductors and three capacitors.

In accordance with a preferred embodiment of the present invention, a T1E1.4 compliant filter circuit used in telecommunication systems for interconnecting between incoming telephone lines and a subscriber's or customer's telephone termination equipment such as a telephone set located at a subscriber's premises for blocking DSL signals so as to prevent interference problems between DSL devices and the subscriber's termination equipment. The compliant filter circuit includes first and second inductors connected in series between a first input terminal and a first output terminal. The first inductor has its one end connected to the first input terminal and its other end connected to one end of the second inductor at a first common point. The second inductor has its other end connected to a first output terminal.

The compliant filter circuit further includes third and fourth inductors connected in series between a second input terminal and a second output terminal. The third inductor has its one end connected to the second input terminal and its other end connected to one end of the fourth inductor at a second common point. The fourth inductor has its other end connected to a second output terminal.

A first capacitor has its one end connected to the first common point and its other end connected to the second common point. A second capacitor has its one end connected also to the first common point and its other end connected to the first output terminal. A third capacitor has its one end connected also to the second common point and its other end connected to the second output terminal.

### BRIEF DESCRIPTION OF THE DRAWINGS

These and other objects and advantages of the present invention will become more fully apparent from the following detailed description when read in conjunction with the accompanying drawings with like reference numerals indicating corresponding parts throughout, wherein:

FIG. 1 is a schematic circuit diagram of a T1E1.4 compliant filter circuit for use with a telephone set having a single line, constructed in accordance with the principles of the present invention;

FIG. 2 is a schematic circuit diagram of a second embodiment of a T1E1.4 compliant filter circuit for use with a telephone set having two lines, in accordance with the principles of the present invention;

FIG. 3 is an exploded, side view of a T1E1.4 compliant filter modular unit housing the filter circuit of FIG. 1;

FIG. 4 is a plan view of the PCB assembly of FIG. 3, taken along the lines 4-4 of FIG. 3;

FIG. 5 is an exploded, side view of a T1E1.4 compliant filter modular unit housing the filter circuit of FIG. 2; and

FIG. 6 is a plan view of the PCB assembly of FIG. 5, taken along the lines 6-6 of FIG. 5.

### DESCRIPTION OF THE PREFERRED EMBODIMENT

As was previously pointed out, the computer user can download information to his/her personal computer from the Internet by receiving DSL data signals transmitted by the ISP. In order to optimize the downloading of this information from the Internet, the user can purchase and install a DSL network interface unit for connection between the computer and the house wiring for receiving the DSL signals from the incoming telephone lines. However, a plurality of telephone sets are typically also connected to the same house wiring. It should be noted that the voice signals from the telephone company and the DSL data signals from the ISP can be transmitted simultaneously over the telephone lines. Further, the voice signals (speech) are in the frequency band between 0 Hz and 4000 Hz, and the DSL data signals are in the frequency band between 25 KHz and 1.1 MHZ.

Unfortunately, when the personal computer connected to the house wiring is downloading information from the ISP, the DSL data signals can cause interference problems with the telephone sets by producing intermodulation distortion and thus noise from the polarity guard bridge in the typical telephone set. The intermodulation distortion signals will have components residing in the DSL frequency band which will cause data errors and therefore data rate reductions as well as audible noise in the voice frequency band.

Therefore, the main purpose of the T1E1.4 compliant filter circuit of the present invention is to isolate the terminal equipment (telephone sets) impedances from the DSL network interface unit and the house wiring so as to reduce interference problems. Further, the compliant filter circuit serves to attenuate sufficiently the DSL data signals, especially in the frequency range of 25-35 KHz, from being received by the telephone sets so as to meet the T1E1.4 voice frequency band requirements but yet minimally affecting the voice band performance. Moreover, in order to facilitate the quick and easy installation by the telephone subscriber or customer without having a trained technician visit the premises and perform the installation, the compliant filter circuit is housed in a modular type adapter design.

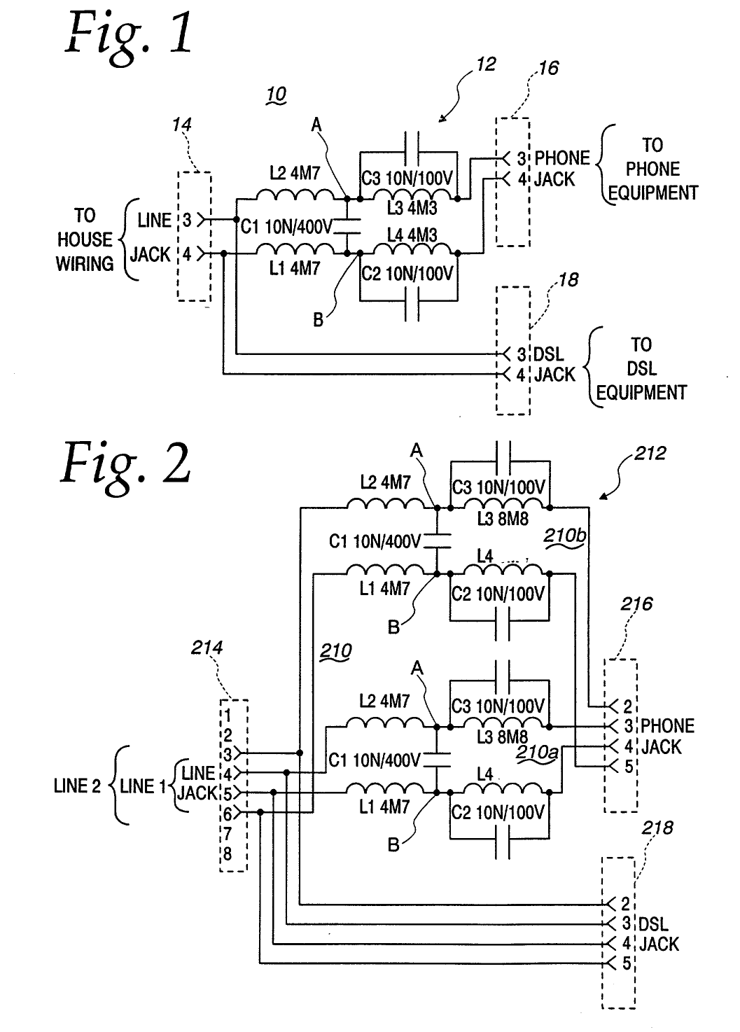

Referring now in detail to the drawings, there is illustrated in FIG. 1 a detailed schematic circuit diagram of a T1E1.4 compliant filter circuit 10, constructed in accordance with the principles of the present invention, which is housed in a modular adapter unit 12. The modular adapter unit 12 includes a first modular input line jack 14 for connection to the incoming telephone lines via the house wiring and a second modular output phone jack 16 for connection to the customer's termination equipment such as a telephone set, answering machine or facsimile (FAX) machine. The modular adapter unit 12 may also include a third modular output DSL pass-through jack 18 for connection to the DSL equipment devices. This output jack 18 is unfiltered on the line connected to the DSL connection. The compliant filter circuit 10 is comprised of four inductors L1-L4 and three capacitors C1-C3.

The inductors L2 and L3 are connected in series between the input tip terminal pin 3 of the input line jack 14 and the output tip terminal pin 3 of the output phone jack 16. Similarly, the inductors L1 and L4 are connected in series between the input ring terminal pin 4 of the input line jack 14 and the output ring terminal pin 4 of the output phone jack 16. The inductors L3 and L4 have the same inductance values, and the inductors L1 and L2 have the same inductance values. The inductor L2 and the inductor L3 are connected together at a common point A and to one side of the capacitor C1. The inductor L1 and the inductor L4 are connected together at a common point B and to the other side of the capacitor C1. The capacitor C3 is connected in parallel with the inductor L3, and the capacitor C2 is connected in parallel with the inductor L4. The capacitors C2 and C3 have the same values. Each of the inductors L1-L4 is preferably formed by a separate winding so as provide longitudinal or common mode inductance for suppressing RF interference (i.e., AM broadcast or Ham radio transmission) as well as creating a differential inductance.

The inductors L1, L2 and the capacitor C1 form basically a second-order low-pass filter section which blocks the DSL data signals being in the frequency range of 25 KHz and 1.1 MHZ from the telephone termination equipment so as to prevent interference problems. However, in order to provide sufficient attenuation for blocking the DSL data signals it was observed that the values of the inductances had to be increased to a large value (on the order of 12 mH) and that the value of the capacitance also had to increased to a large value (on the order of 22 nF). It was found that these larger values created too much attenuation and impedance distortion of the voice band signals.

In order to overcome this problem, the values of the inductances and the capacitance were reduced to be acceptable in the voice band. However, the lower values did not produce sufficient attenuation at the beginning of the DSL frequency band of 25 KHz. To solve this situation, the inventor has added an elliptical filter section consisting of the inductors L3, L4 and the capacitors C2, C3 which forms an elliptical zero or dead band in the frequency range of 25-35 KHz. Thus, the values of the inductors and capacitors are selected so to provide the desired attenuation in the frequency range of 25-35 KHZ so as to meet the specification of the T1E1.4 voice band with minimal adverse voice band performance.

For completeness in the disclosure of the above-described compliant filter circuit but not for purposes of limitation, the following representative values and component identifications are submitted. These values and components were employed in a compliant filter circuit that was constructed and tested, and which provides high quality performance.

| PART | TYPE or VALUE | |
|---|---|---|
| L1, L2 | 4.7 | mH |
| L3, L4 | 4.3 | mH |
| C1 | 10 | nf |
| C2, C3 | 10 | nf |

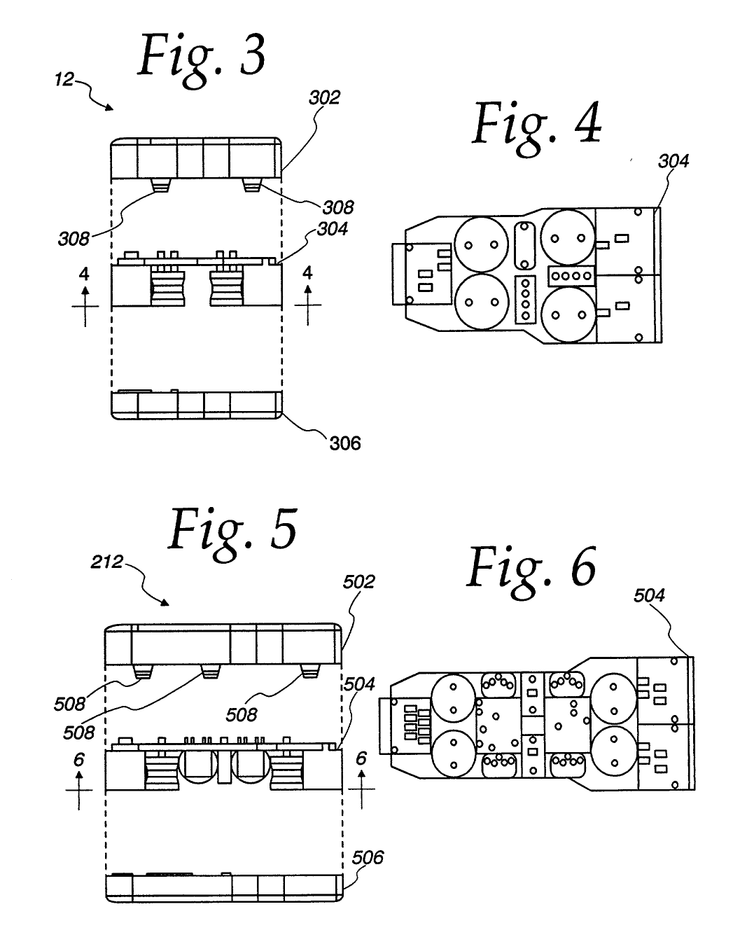

In FIG. 3, there is depicted an exploded side view of the modular adapter unit 12 of FIG. 1 which will now be explained. The modular adapter unit 12 is comprised of a top cover member 302, a PCB (printed circuit board) assembly 304, and a bottom base plate 306. The PCB assembly 304 is used to mount the electrical components of the compliant filter circuit 10 depicted in the schematic diagram of FIG. 1. In FIG. 4, there is shown a plan layout view of the PCB assembly 304, taken along the lines 4-4 of FIG. 3.

The top cover member 302 is provided with a plurality (two) of retaining posts 308. The retaining posts extend downwardly and adapted to mate with the retaining holes formed in the bottom base member 306. In assembly, the PCB assembly 304 is placed into the bottom base member 306. Then, the cover member 302 is placed over the PCB assembly 304 so that the retaining posts 308 are received snappingly into the retaining holes in the bottom base member 306, thereby sandwiching the PCB assembly 304 therebetween. The cover member 302 and the bottom base member 306 are secured together by any conventional means such as hooks formed on the retaining post 308 or by ultrasonic welding on the mating surfaces and the like.

In FIG. 2, there is shown a detailed schematic circuit diagram of a second embodiment of a dual T1E1.4 compliant filter circuit 210 for use with a telephone set having two lines which is housed in a modular adapter unit 212. The modular adapter unit 212 includes a first modular input line jack, a second modular output phone jack 216, and an optional third modular output DSL jack 218. The dual compliant filter circuit 210 is comprised of a first compliant filter circuit 210a connectable to a first line of the telephone set and a second compliant filter circuit 210b connectable to a second line of the telephone set. Since each of the first and second filter circuits 210a, 210b is substantially identical to the single compliant filter circuit 10 of FIG. 1, only the differences will now be described.

In order to minimize the effect of the cross-talk, the inductors L3, L4 in the elliptical sections of the first and second filter circuits 210a, 210b are inserted into a corresponding ferrite sleeve which serves to provide shielding and thus reduces the cross-talk. The shielding also reduces the coupling from the low-pass filter section to the elliptical section. The cross-talk between the first line (line 1) and the second line (line 2) is reduced sufficiently by locating the inductors L1, L2 of the first and second filters on opposite ends of the printed circuit board, as illustrated in FIG. 6. The ferrite sleeve also serves as a shield by being disposed between the inductors L1, L2.

In FIG. 5, there is depicted an exploded side view of the modular adapter unit 212 of FIG. 2 which will now be explained. The modular adapter unit 212 is comprised of a top cover member 502, a PCB (printed circuit board) assembly 504, and a bottom base plate 506. The PCB assembly 504 is used to mount the electrical components of the dual compliant filter circuit 210 depicted in the schematic diagram of FIG. 2. In FIG. 6, there is shown a plan layout view of the PCB assembly 504, taken along the lines 6-6 of FIG. 5.

The top cover member 502 is provided with a plurality (three) of retaining posts 508. The retaining posts extend downwardly and adapted to mate with the retaining holes formed in the bottom base member 506. In assembly, the PCB assembly 504 is placed into the bottom base member 506. Then, the cover member 502 is placed over the PCB assembly 504 so that the retaining posts 508 are received snappingly into the retaining holes in the bottom base member 506, thereby sandwiching the PCB assembly 504 therebetween. The cover member 502 and the bottom base member 506 are secured together by any conventional means such as hooks formed on the retaining post 508 or by ultrasonic welding on the mating surfaces and the like.

From the foregoing detailed description, it can thus be seen that the present invention provides a compliant filter circuit used in telecommunication systems for interconnecting between incoming telephone lines and a subscriber's telephone termination equipment located at a subscriber's premises for blocking DSL signals so as to prevent interference problems between DSL devices and the subscriber's termination equipment. The compliant filter circuit is comprised of four inductors and three capacitors.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

1. A T1E1.4 compliant filter circuit used in telecommunication systems for interconnecting between incoming telephone lines and a subscriber's telephone termination equipment located at a subscriber's premises for blocking DSL signals so as to prevent interference problems between DSL devices and the subscriber's termination equipment, said compliant filter circuit comprising:
first and second inductors connected in series between a first input terminal and a first output terminal;
said first inductor having its one end connected to said first input terminal and its other end connected to one end of said second inductor at a first common point, said second inductor having its other end connected to said first output terminal;
third and fourth inductors connected in series between a second input terminal and a second output terminal;
said third inductor having its one end connected to said second input terminal and its other end connected to one end of said fourth inductor at a second common point, said fourth inductor having its other end connected to said second output terminal;
a first capacitor having its one end connected to said first common point and its other end connected to said second common point;
a second capacitor having its one end connected to said first common point and its other end connected to said first output terminal; and
a third capacitor having its one end connected to said second common point and its other end connected to said second output terminal.

2. A T1E1.4 compliant filter circuit as claimed in claim 1, wherein said first and third inductors have values on the order of 4.7 mH.

3. A T1E1.4 compliant filter circuit as claimed in claim 2, wherein said second and fourth inductors have values on the order of 4.3 mH.

4. A T1E1.4 compliant filter circuit as claimed in claim 3, wherein said first capacitor has a value on the order of 10 nF.

5. A T1E1.4 compliant filter circuit as claimed in claim 4, wherein said second and third capacitors have values on the order of 10 nF.

6. A T1E1.4 compliant filter circuit as claimed in claim 1, wherein said first inductor, second inductor and first capacitor function as a second-order low-pass filter section so as to block the DSL data signals from said termination equipment.

7. A T1E1.4 compliant filter circuit as claimed in claim 6, wherein said second inductor, fourth inductor, second capacitor and third capacitor function as an elliptical filter section so as to block the DSL data signals in a frequency band of 25-35 KHz.

8. A T1E1.4 compliant filter circuit as claimed in claim 1, wherein said first through fourth inductors and said first through third capacitors are housed in a modular type design.

9. A T1E1.4 compliant filter circuit as claimed in claim 8, wherein said modular design is capable of self-installation by a subscriber.

10. A T1E1.4 compliant filter circuit used in telecommunication systems for interconnecting between incoming telephone lines and a subscriber's telephone termination equipment located at a subscriber's premises for blocking DSL signals so as to prevent interference problems between DSL devices and the subscriber's termination equipment, said compliant filter circuit comprising:
a low-pass filter section formed of first and second inductors and a first capacitor;
said first inductor having a first end connected to a first input terminal and a second end;
said second inductor having a first end connected to a second input terminal and a second end;
said first capacitor having a first end connected to said second end of said first inductor and having a second end connected to said second end of said second inductor;
an elliptical filter section formed of third and fourth inductors and second and third capacitors;
said third inductor and said second capacitor being connected in parallel and having their one end joined also to said second end of said first inductor and their other end joined to a first output terminal; and
said fourth inductor and said third capacitor being connected in parallel and having their one end joined also to said second end of said second inductor and their other end joined to a second output terminal.

11. A T1E1.4 compliant filter circuit as claimed in claim 10, wherein said first and second inductors have values on the order of 4.7 mH.

12. A T1E1.4 compliant filter circuit as claimed in claim 11, wherein said third and fourth inductors have values on the order of 4.3 mH.

13. A T1E1.4 compliant filter circuit as claimed in claim 12, wherein said first capacitor has a value on the order of 10 nF.

14. A T1E1.4 compliant filter circuit as claimed in claim 13, wherein said second and third capacitors have values on the order of 10 nF.

15. A T1E1.4 compliant filter circuit as claimed in claim 10, wherein said first through fourth inductors and said first through third capacitors are housed in a modular type design.

16. A T1E1.4 compliant filter circuit as claimed in claim 15, wherein said modular design is capable of self-installation by a subscriber.

17. A T1E1.4 compliant filter circuit as claimed in claim 8, wherein said modular type design includes a first modular input line jack for connection to the incoming telephone lines and a second modular output telephone jack for connection to the subscriber's termination equipment.

18. A T1E1.4 compliant filter circuit as claimed in claim 17, wherein said modular type design further includes a third modular output DSL pass-through jack for connection to the DSL devices.

19. A T1E1.4 compliant filter circuit as claimed in claim 15, wherein said modular type design includes a first modular input line jack for connection to the incoming telephone lines and a second modular output telephone jack for connection to the subscriber's termination equipment.

20. A T1E1.4 compliant filter circuit as claimed in claim 19, wherein said modular type design further includes a third modular output DSL pass-through jack for connection to the DSL devices.
